(19) United States
(12) Patent Application Publication
(10) Pub. No.: US 2024/0239692 A1
(43) Pub. Date: Jul. 18, 2024

(54) METHOD FOR REGENERATING WATER SOFTENER

(71) Applicant: SAUDI ARABIAN OIL COMPANY, Dhahran (SA)

(72) Inventors: Khaled Kamal Bekair, Abqaiq (SA); Abdulaziz A. Subaie, Dhahran (SA); Khaled Talal Wahbo, Dammam (SA); Ibrahim J. Makrami, Alkhobar (SA); Mohammed Abdulrahman Mugahwi, Dammam (SA)

(73) Assignee: SAUDI ARABIAN OIL COMPANY, Dhahran (SA)

(21) Appl. No.: 18/153,390

(22) Filed: Jan. 12, 2023

(51) Int. Cl. C02F 1/42; C02F 1/44

(52) U.S. Cl. CPC C02F 1/42; C02F 1/441; C02F 2001/425; C02F 2103/06

(57) ABSTRACT

The method includes concentrating a source water including sodium ions and at least one of calcium and magnesium ions with a reverse osmosis filter to produce a reject water containing sodium ions and at least one of calcium and magnesium ions, adding sodium ions to the reject water to produce a regeneration water, and feeding the regeneration water through a water softener including a resin containing at least one of calcium and magnesium ions. The regeneration water has Na⁺: (Mg²⁺+Ca²⁺) of 10:1 to 10000:1. The method includes desalinating groundwater in a desalination plant to produce purified water and a groundwater concentrate, adding sodium ions to the groundwater concentrate to produce regeneration water, cyclically feeding a process water to a water softener containing an ion exchange resin and feeding the regeneration water to the water softener containing spent ion exchange resin and regenerating the spent ion exchange resin.

### BACKGROUND

Soft water is water having a low concentration of multivalent salt metal ions, or salt metal ions having 2 or more valency including calcium, magnesium and iron, and is often used in various applications such as cooling towers for oil and gas industry, in a refinery or a chemical plant. In order to supply a substantially large amount of soft water required by the industry, soft water generation plants are built, in which water softeners are used to produce the required soft water, or soft water process stream, from a process water including hard water. A water softener, which is an ion exchanger, generally includes a vessel containing an ion exchange resin containing ions such as sodium ions, potassium ions or a combination thereof. Water to be softened, such as the process water, is passed through the water softener, and the sodium ions in the resin are replaced by the multivalent salt metal ions in the water, thereby producing soft water.

The ion exchange resin in the water softener becomes spent or saturated with the salt metal ions after substantial use. A regeneration process is generally conducted by introducing an aqueous solution containing sodium ions, or regeneration water, to the water softener containing the spent ion exchange resin. The sodium ions replace the salt metal ions, thereby reversing the water softening process. The spent ion exchange resin becomes a regenerated resin and the regeneration water becomes a hardened regeneration water containing the salt metal ions. The regenerated water softener is then used to soften the process water and upon saturation of the ion exchange resin, the regeneration process is repeated. The softening of process water and regeneration of the water softener are conducted cyclically.

The solution containing sodium ions used for the regeneration process is generally prepared by mixing natural salt with groundwater. The regeneration process may consume a substantial amount of salt and groundwater, which has negative environmental and economic impact.

Furthermore, a desalination, or a water purification process often includes the use of a reserve osmosis (RO) to produce purified water from a source water, such as groundwater, wastewater and seawater. Such desalination may be conducted in a desalinating plant. The purified water may have numerous applications, such as a feed water for a boiler, or steam generation. In reverse osmosis, a pressure is applied to the fluid introduced to a RO filter to transfer a portion of the fluid to produce purified water. The portion that remains unfiltered is a reject water which may comprise ions which do not pass through the RO filter The reject water generated by the RO filter in a process such as desalination or water purification is often discarded as a waste product, which also has negative environmental and economic impact.

Accordingly, there exists a need for continuing improvement of the water purification process and the regeneration process of water softeners.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for regenerating a water softener. The method includes concentrating a source water comprising sodium ions and at least one of calcium ions and magnesium ions with a reverse osmosis (RO) filter to produce a regeneration water, and feeding the regeneration water through the water softener comprising a resin comprising at least one of calcium ions and magnesium ions to replace the at least one of calcium ions and magnesium ions with the sodium ions comprised in the regeneration water. The regeneration water has a ratio of sodium ions to a sum of magnesium ions and calcium ions in a range of from 10:1 to 10000:1.

In another aspect, embodiments disclosed herein relate to a method for producing and processing multiple water feed. The method includes concentrating a source water comprising sodium ions and at least one of calcium ions and magnesium ions with an RO filter to obtain a reject water and a purified water, adding sodium ions to the reject water to produce a regeneration water, feeding the regeneration water through a water softener comprising a resin comprising at least one of calcium ions and magnesium ions to replace the at least one of calcium ions and magnesium ions with the sodium ions comprised in the regeneration water, and feeding the purified water through a process that requires a low solute concentration. The regeneration water has a ratio of sodium ions to a sum of magnesium ions and calcium ions in a range of from 10:1 to 10000:1, and the source water includes at least one of wastewater, groundwater and seawater.

In one aspect, embodiments disclosed herein relate to a method including desalinating groundwater in a desalination plant to produce a purified water stream and a groundwater concentrate stream, adding sodium ions to the groundwater concentrate stream to produce a regeneration water having a ratio of sodium ions to a sum of magnesium ions and calcium ions in a range of from 10:1 to 10000:1, feeding the purified water to a boiler or a steam generator to produce steam, and using the steam as a heat exchange medium in one or more heat exchangers of a refinery or a chemical plant.

The method also includes feeding a process water stream of the refinery or the chemical plant to a water softener containing an ion exchange resin comprising sodium ions to produce a soft water process stream and a water softener containing spent ion exchange resin, and feeding the regeneration water to the water softener containing spent ion exchange resin and regenerating the spent ion exchange resin. The process water stream includes hard water which contains greater than 50 mg/L to less than 5,000 mg/L of calcium and magnesium ions. The regeneration of the spent ion exchange resin is conducted by exchanging calcium and magnesium ions contained in the resin with sodium ions contained in the regeneration water to produce a regenerated resin and a hardened regeneration water. The feeding of the process water stream to the water softener and the feeding of the regeneration water to the water softener are conducted cyclically.

Other aspects and advantages of the claimed subject matter will be apparent from the following description and the appended claims.

### DETAILED DESCRIPTION

In one aspect, embodiments disclosed herein relate to a method for regenerating a water softener. In one or more embodiments, the method includes concentrating a source water comprising sodium ions and at least one of calcium ions and magnesium ions with a reverse osmosis (RO) filter to produce a reject water that is a regeneration water, and feeding the regeneration water through a water softener comprising a resin comprising at least one of calcium ions and magnesium ions.

In another aspect, embodiments disclosed herein relate to a method for producing and processing multiple water feeds. The method comprises concentrating a source water comprising sodium ions and at least one of calcium ions and magnesium ions with a reverse osmosis (RO) filter to obtain a reject water and a purified water, adding sodium ions to the reject water to produce a regeneration water, feeding the regeneration water through the water softener comprising a resin comprising at least one of calcium ions and magnesium ions to replace the at least one of calcium ions and magnesium ions with the sodium ions comprised in the regeneration water, and feeding the purified water through a process comprising at least one of a boiler and a steam generator. The regeneration water may have a ratio of sodium ions to a sum of magnesium ions and calcium ions in a range of from 10:1 to 10000:1, and the source water may include at least one of wastewater, groundwater and seawater.

In the present disclosure, “wastewater” refers to water generated through an artificial process which is discarded into the environment. Wastewater, groundwater and seawater may comprise a multiplicity of salts, such as sodium, potassium, magnesium calcium and chlorine. Because of the multiplicity of salt ions in the wastewater, groundwater and seawater, the regeneration water produced by an RO filter, such as in a water desalination plant, from a source such as wastewater, groundwater and seawater was generally considered unsuitable for use as a source of sodium ions to regenerate a water softener. However, the present inventors found that such regeneration water may be effectively used to regenerate saturated water softener.

### Concentration of Source Water

In one or more embodiments, the method includes concentrating a source water comprising sodium ions and at least one of calcium ions and magnesium ions with an RO filter to produce a regeneration water.

In one or more embodiments, the source water is any water comprising sodium ions and suitable for the use in an RO filter. The source water may be groundwater, seawater or wastewater comprising sodium ions. In one or more embodiments, the concentration of sodium ions in the source water is in a range from about 50 mg/L to about 20,000 mg/L, such a lower limit selected from any one of 50, 100, 200, 300, 400 and 500 mg/L to an upper limit selected from any one of 650, 700, 800, 900, 1000, 2000, 3000, 4000, 5000, 10,000, and 20,000 mg/L where any lower limit may be paired with any upper limit. In one or more embodiments, the concentration of sodium ions in the source water is about 600 mg.

The source water may also comprise chlorine ions. The source water may include chlorine ions in any concentration. In one or more embodiments, the concentration of chlorine ions in the source water is in a range from about 0 mg/L to about 30,000 mg/L, such a lower limit selected from any one of 0, 50, 100, 200, 300, 400 and 500 mg/L to an upper limit selected from any one of 650, 700, 800, 900, 1000, 2000, 3000, 4000, 5000, 10,000, 20,000, and 30,000 mg/L where any lower limit may be paired with any upper limit.

The source water may also comprise calcium and magnesium ions. The source water may include calcium ions in any concentration. In one or more embodiments, the concentration of calcium ions in the source water may be in a range from about 0 mg/L to 500 mg/L, such as a lower limit selected from any one of 0, 10, 20, 30, 40, and 50 mg/L to an upper limit selected from any one of 10, 20, 50, 100, 200, 300, 400 and 500 mg/L, where any lower limit may be paired with any mathematically compatible upper limits.

The concentration of magnesium ions in the source water may be in a range from about 0 mg/L to 2000 mg/L, such as a lower limit selected from any one of 0, 5, 10, 50, and 100 mg/L to an upper limit selected from any one of 10, 20, 50, 100, 200, 300, 400, 500, 1000 and 2000 mg/L, where any lower limit may be paired with any mathematically compatible upper limits.

In one or more embodiments, the source water to be concentrated is treated prior to being concentrated in the RO filter. The treatment may include removal of solid particles with filters such multimedia filters and micron filters. In one or more embodiments, the source water is concentrated without being treated prior to the concentration step. In one or more embodiments, the treatment of the source water includes adding components such as a scale inhibitor and sodium bisulfate for chlorine removal. The source water may be fed through a cooling tower.

In one or more embodiments, The RO filter for concentrating the source water comprises a vessel capable of withstanding a positive pressure, and at least one RO membrane located in the vessel. The RO membrane separates or divides inside of the vessel into a reject side and a permeate side such that the fluid in the RO filter cannot flow from the reject side to the permeate side without flowing through the RO membrane. The RO filter also comprises a feed inlet, a reject outlet on the reject side and a permeate outlet on the permeate side.

As noted previously, in reverse osmosis, a pressure is applied to the fluid introduced through the feed inlet into the reject side of the vessel. A portion of the fluid is transferred to the permeate side. In one or more embodiments, the RO membrane is a semi-permeable membrane which comprises microscopic pores. The semi-permeable membrane is designed such that the membrane allows only certain molecules to pass through based on the molecule size, chemistry and/or solubility. In one or more embodiments, the RO membrane may be an RO membrane commonly used in the art, and any suitable RO membrane may be used.

In the concentration step of the present method, the source water is introduced into the reject side of the RO filter and a pressure is applied to separate the source water. Reject water, which is a portion of the source water that does not flow through the RO membrane, is collected from the reject outlet. The fluid collected from the permeate outlet is purified water and has a low solute concentration. In one or more embodiments, the reject water may be used as the regeneration water. In one or more embodiments, sodium ions may be added to the reject water to produce the regeneration water, as described in detail in the subsequent section.

A purified water having a “low solute concentration” refers to a purified water having a total dissolved solid (TDS) concentration of less than 500 mg/L, such as less than 500 mg/L, 400 mg/L, 350 mg/L, 300 mg/L, 250 mg/L, 200 mg/L, 150 mg/L, and 100 mg/L. In one or more embodiments, a purified water having a low solute concentration has a TDS concentration in a range of from about 0 mg/L to about 500 mg/L, such as a lower limit selected from any one of 0, 25, 50, and 75 mg/L to an upper limit selected from any one of 100, 150,200, 250, 300, 350, 400, 450 and 500 mg/L, where any lower limit may be paired with any upper limit.

In one or more embodiments, the regeneration water is a reject water collected from the RO reject side of the RO filter, or groundwater concentrate, that is being used in a process, such as desalination or water purification, for producing purified water. The reject water generated in a desalination or water purification is typically discarded as a waste product. The reject water may have a sodium concentration of at least 500 mg/L, or at least 1000 mg/L. The reject water, or groundwater concentrate, may have at least one of calcium ions and magnesium ions, and the concentration of at least one of calcium ions and magnesium ions may be in a range of about 50 to about 5,000 mg/L, such as a lower limit selected from any one of 50, 100, 200, 300, 400 and 500, to an upper limit selected from any one of 300, 400, 500, 1000, 2000, 3000, 4000 and 5000 mg/L, where any lower limit may be paired with any mathematically compatible upper limit.

In one or more embodiments, the method includes adding sodium ions, such as sodium chloride, to the reject water produced in the step of concentrating the source water to produce a regeneration water. Sodium chloride may be added to the reject water such that the sodium ion concentration of the regeneration water is at least 50,000 mg/L, or in a range from about 50,000 mg/L to about 100,000 mg/L, such as a lower limit selected from any one of 50,000, 55,000, 60,000 mg/L to an upper limit selected from any one of 80,000, 90,000 and 100,000 mg/L, where any lower limit may be paired with any upper limit.

In one or more embodiments, the produced purified water generated in the concentration step is fed through a process or apparatus that requires purified water having a low solute concentration, such as steam generator, or a boiler as a boiler feed water. Embodiments herein may thus integrate water desalination plants generating sodium containing wastewater with nearby chemical processing plants or refineries that require soft water, such as for cooling water systems, utilizing the waste salt water stream that is typically discarded as a valuable resource.

In one or more embodiments, the produced regeneration water comprises sodium ions. The regeneration water may have a sodium ion concentration of at least 50,000 mg/L, or in a range from about 50,000 mg/L to about 100,000 mg/L, such as a lower limit selected from any one of 50,000, 55,000, 60,000 mg/L to an upper limit selected from any one of 80,000, 90,000 and 100,000 mg/L, where any lower limit may be paired with any upper limit. The concentration of sodium ions may be determined by ASTM D 1976, for example. The regeneration water having the above-mentioned concentration may be obtained by adding sodium chloride to the reject water obtained from the RO filter, if necessary.

In one or more embodiments, the regeneration water comprises chlorine ions. The regeneration water may have a chlorine ion concentration in a range from about 0 mg/L to about 150,000 mg/L, such as a lower limit selected from any one of 0, 10,000, 20,000 mg/L, to an upper limit selected from any one of 100,000, 125,000 and 150,000 mg/L, where any lower limit may be paired with any upper limit. The concentration of chlorine ions may be determined by ASTM D 512, for example.

In one or more embodiments, the regeneration water comprises calcium ions. The regeneration water may have a calcium ion concentration in a range of from about 0 to about 3000 mg/L, such as a lower limit selected from any one of 0, 25, 50, 75, and 100 mg/L to an upper limit selected from any one of 100, 250, 500, 750, 1000, 2000 and 3000 mg/L, where any lower limit may be paired with any upper limit. The concentration of calcium ions may be determined by ASTM D 1976 or APHA2340B, for example.

In one or more embodiments, the regeneration water comprises magnesium ions. The regeneration water may have a magnesium ion concentration in a range of from about 0 to about 2000 mg/L, such as a lower limit selected from any one of 0, 10, 20, 30, 40, 50, 60, 70, 80, 90 and 100 mg/L to an upper limit selected from any one of 150, 175, 200, 225, 250, 275, 300, 350, 400, 450, 500, 1000 and 2000 mg/L, where any lower limit may be paired with any upper limit. The concentration of magnesium ions may be determined by ASTM D 1976 or APHA2340B, for example. The maximum permissible upper limit for each of calcium and magnesium in the regeneration water may be greater than the above noted values. However, these ions should be present at a significantly lower concentration than the sodium ions.

In one or more embodiments, a ratio of sodium ions to a sum of magnesium and calcium ions in the regeneration water (Na⁺: (Mg²⁺+Ca²⁺)) is in the range of 10:1 to 10000:1, such as a lower limit selected from any one of 10:1, 15:1 and 20:1, to an upper limit selected from any one of 100:1, 1000:1 and 10000:1 where any lower limit may be paired with any upper limit. In one or more embodiments, Na⁺: (Mg²⁺+Ca²⁺) may be 100:3.

In one or more embodiments, the regeneration water has a total hardness in a range of from about 3000 to about 5000 mg/L. The total hardness may be determined by APHA340B, for example.

In one or more embodiments, the regeneration water has a conductivity in a range of at least 150,000 uS/cm. In one or more embodiments, the regeneration water has a conductivity in a range of from about 150,000 to about 300,000 uS/cm, such as a lower limit selected from any one of 150,000, 175,000 and 200,000 uS/cm, to an upper limit selected from any one of 250,000, 275,000 and 300,000 uS/cm, where any lower limit may be paired with any upper limit.

In one or more embodiments, the regeneration water has an alkalinity in a range of from about 100 to about 600 mg/L.

In one or more embodiments, the regeneration water has a pH in a range of from about 7.0 to about 8.0.

In one or more embodiments, the regeneration water has a specific gravity of at least 1.05. In one more embodiments, the regeneration water has a specific gravity in a range of from about 1.05 to about 1.40, such as from a lower limit selected from any one of 1.05, 1.075, and 1.10 to an upper limit selected from any one of 1.20, 1.25, 1.30, 1.35 and 1.40, where any lower limit may be paired with any upper limit.

In one or more embodiments, the flow rate of the reject water in the concentrating step is in a range of from about 250 gallons per minute (gpm) to 350 gpm, or about 300 gpm.

The source water in the concentrating step may have a temperature in a range of from about 5 to 45° C., such as a lower limit selected from any one of 5, 10, 15° C. to an upper limit selected from any one of 25, 30, 35, 40 and 45° C., where any lower limit may be paired with any upper limit.

In one or more embodiments, the flow rate of the produced regeneration water in the concentrating step is in a range of from about 100 to about 300 gpm.

In one or more embodiments, the concentrating is conducted at a temperature in a range of from about 5 to about 45° C., such as a lower limit selected from any one of 5, 10, 15° C. to an upper limit selected from any one of 25, 30, 35, 40 and 45° C., where any lower limit may be paired with any upper limit.

In one or more embodiments, the concentrating is conducted at a pressure in a range of from about 10 to about 40 psig, such as a lower limit selected from any one of 10, 15, and 20 psig, to an upper limit selected from any one of 30, 35 and 40 psig, where any lower limit may be paired with any upper limit.

In one or more embodiments, the concentrating is conducted with a single RO filter, or a plurality of RO filters. In case the concentrating is conducted with a plurality of RO filters, the RO filters may be arranged in series, in parallel or combinations thereof.

### Regeneration of Water Softener

In one or more embodiment, the method includes feeding the regeneration water through a water softener comprising a resin comprising at least one of calcium ions and magnesium ions. Sodium ions comprised in the regeneration water that are fed through the water softener replaces salt metal ions, which includes at least one of calcium ions and magnesium ions, comprised in the resin. The at least one of calcium ions and magnesium ions dissolves into the regeneration water and exits the water softener.

As noted previously, a water softener, which is an ion exchanger, generally comprises a vessel and a resin comprised in the vessel. The resin at a regenerated state comprises sodium ions, potassium ions or a combination thereof. A feed water comprising multivalent salt metal ions, which may include at least one of calcium ions and magnesium ions, is introduced through the water softener and the multivalent salt metal ions replaces the sodium ions comprised in the resin, and the multivalent salt metal ions is removed from the feed water. The ion exchanging process in the water softener may be expressed as follows:

$${Ca}^{+ 2} + {Na}_{2} \cdot X \to Ca \cdot X + 2 {Na}^{+ 1} \qquad ( 1 )$$

$${Mg}^{+ 2} + {Na}_{2} \cdot X \to Mg \cdot X + 2 {Na}^{+ 1} \qquad ( 2 )$$

where X represents resin particles.

Once the resin becomes saturated with the multivalent salt metal ions, a regeneration of the resin is conducted to remove the multivalent salt metal ions from the resin in the water softener. The regeneration process includes introducing an aqueous solution comprising sodium ions through the water softener to replace the multivalent salt metal ions with the sodium ions. The regeneration process can be expressed as the reverse reactions of the ion exchanges described in equations (1) and (2).

In one or more embodiments, the resin comprised in the water softener is any resin commonly used in a water softener. The resin may be an organic polymer having anionic functional groups to which multivalent cations, such as calcium and magnesium ions, may bind more strongly than monovalent cations, such as sodium. In one or more embodiments, the resin comprises polystyrene and acrylic polymer. The shape of the resin may be any shape commonly used in the art, such as pellets, beads, and particles.

In one or more embodiments, the feeding of regeneration water through a water softener is conducted at a flow rate in a range from about 100 to about 500 gallons per minute (gpm), such as a lower limit selected from any one of 100, 150, 200, 250 gpm to an upper limit selected from any one of 350, 400, 450 and 500 gpm, where any lower limit may be paired with any upper limit. In one or more embodiments, the feeding is conducted at a flow rate of about 300 gpm.

In one or more embodiments, the feeding is conducted at a temperature in a range from about 5 to about 45° C., such as a lower limit selected from any one of 5, 10, 15° C. to an upper limit selected from any one of 25, 30, 35, 40 and 45° C., where any lower limit may be paired with any upper limit.

In one or more embodiments, the feeding is conducted at a pressure in a range from about 30 to about 40 psig, or at a pressure of about 40 psig.

In one or more embodiments, the feeding is conducted for a duration in a range from about 30 minutes to about 120 minutes, such as a lower limit selected from any one of 30, 40, and 45 minutes to an upper limit selected from any one of 60, 80, 100 and 120 minutes, where any lower limit may be paired with any upper limit. The feeding of regeneration water for the duration as above provides sufficient regeneration of the water softener such that the soft water obtained after the feeding process has a total hardness of 10 ppm or less.

In one or more embodiments, the feeding is conducted with a regeneration water which is a reject water obtained directly from the RO filter, without dissolving additional sodium.

### EXAMPLES

The following examples are provided to illustrate embodiments of the present disclosure. The Examples are not intended to limit the scope of the present invention, and they should not be so interpreted.

### Example 1

The method for regenerating a water softener was conducted by first concentrating a groundwater through an RO filter. The groundwater (“Sample 1”) and water obtained from the water softener before conducting the regeneration process (“Sample 2”) were obtained and analyzed for their contents and properties. Samples from the water softeners are periodically collected and analyzed to determine whether or not a regeneration process is required. The summary of water analyses is provided in Table 1.

TABLE 1

| Ion concentrations | | Sample | Sample |
|---|---|---|---|
| (mg/L) | | 1 | 2 |
| Sulfate (SO₄) | ASTM D516 | 511 | 546 |
| Chloride (Cl) | ASTM D512 | 1048 | 1045 |
| Barium (Ba) | ASTM D1976 | 0.04 | <0.01 |
| Strontium (Sr) | ASTM D1976 | 4.6 | 0.09 |
| Potassium (K) | ASTM D1976 | 37.0 | 22.4 |
| Calcium (Ca) | ASTM D1976 | 236 | 2.46 |
| Magnesium (Mg) | ASTM D1976 | 92.8 | 1.43 |
| Sodium (Na) | ASTM D1976 | 600 | 1000 |
| CO₃ | ASTM D3875 | 0 | 0 |
| HCO₃ | ASTM D3875 | 351 | 357 |
| OH | ASTM D3875 | 0 | 0 |
| Alkalinity | ASTM D3875 | 287 | 293 |
| (CaCO₃) (mg/L) | | | |
| pH | ASTM D1293 | 7.52 | 7.6 |
| Conductivity (uS/cm) | ASTM D1125 | 4500 | 4750 |
| Specific Gravity | ASTM D4052 | 1.0023 | 1.0023 |

The groundwater was first fed through multimedia filters and micron filters, and sodium bisulfate and a scale inhibitor were added to the groundwater prior to feeding through the RO filter. The groundwater was then fed through the RO filter and the reject water was obtained from the RO filter. The obtained reject water was then fed into a mixing pit where sodium chloride was added to the reject water to produce regeneration water. The regeneration water with added sodium chloride was fed into a temporary holding pit with a pump, and the regeneration water was pumped into a saturated water softener. The reject water from the RO filter (“Sample 3”), the regeneration water in the mixing pit (“Sample 4”), the regeneration water in the holding pit (“sample 5”), and the treated soft water obtained from the water softener after the regeneration process (“Sample 6”), were analyzed for their contents and properties. A summary of water analyses is provided in Table 2.

TABLE 2

| Ion concentrations | | Sample | Sample | Sample | Sample |
|---|---|---|---|---|---|
| (mg/L) | | 3 | 4 | 5 | 6 |
| Sulfate (SO₄) | ASTM D516 | 1510 | 1930 | 2170 | 529 |
| Chloride (Cl) | ASTM D512 | 1591 | 53209 | 88503 | 905 |
| Barium (Ba) | ASTM D1976 | 0.13 | 0.09 | 0.09 | 0.01 |
| Strontium (Sr) | ASTM D1976 | 13 | 15 | 47 | 0.11 |
| Potassium (K) | ASTM D1976 | 89.5 | 145 | 189 | 2.96 |
| Calcium (Ca) | ASTM D1976 | 638 | 883 | 1060 | 1.96 |
| Magnesium (Mg) | ASTM D1976 | 233 | 340 | 413 | 0.97 |
| Sodium (Na) | ASTM D1976 | 990 | 36000 | 62000 | 980 |
| CO₃ | ASTM D3875 | 0 | 0 | 0 | 0 |
| HCO₃ | ASTM D3875 | 685 | 576 | 382 | 227 |
| OH | ASTM D3875 | 0 | 0 | 0 | 0 |
| Alkalinity | ASTM D3875 | 562 | 472 | 313 | 186 |
| (CaCO₃) (mg/L) | | | | | |
| pH | ASTM D1293 | 7.61 | 7.89 | 7.48 | 7.44 |
| Conductivity | ASTM D1125 | 8120 | 124000 | 186500 | 4340 |
| (uS/cm) | | | | | |
| Specific Gravity | ASTM D4052 | 1.0048 | 1.0648 | 1.0099 | 1.0021 |

### Example 2

The method for regenerating a water softener as described in EXAMPLE 1 was conducted daily over approximately 2 months, and the regeneration water in the mixing pit (“Sample 7”), and the treated soft water (“Sample 8”) and waste water (“Sample 9”) obtained from the water softener during the regeneration process were analyzed for their contents and properties. The summary of water analyses is provided in Table 3.

TABLE 3

| Ion concentrations | | Sample | Sample | Sample |
|---|---|---|---|---|
| (mg/L) | | 7 | 8 | 9 |
| Sulfate (SO₄) | ASTM D516 | 3250 | 643 | 3210 |
| Chloride (Cl) | ASTM D512 | 81915 | 2576 | 75817 |
| Barium (Ba) | ASTM D1976 | 0.114 | <0.05 | 0.911 |
| Strontium (Sr) | ASTM D1976 | 19 | 0.099 | 43 |
| Potassium (K) | ASTM D1976 | 265 | 10 | 218 |
| Calcium (Ca) | ASTM D1976 | 913 | 0.073 | 1470 |
| Calcium (Ca) | APHA2340B | 913 | 0.073 | 1470 |
| Magnesium (Mg) | ASTM D1976 | 545 | 1.03 | 558 |
| Magnesium (Mg) | APHA2340B | 545 | 1.03 | 558 |
| Sodium (Na) | ASTM D1976 | 56000 | 2200 | 52000 |
| CO₃ | ASTM D3875 | 0 | 0 | 0 |
| HCO₃ | ASTM D3875 | 385 | 262 | 393 |
| OH | ASTM D3875 | 0 | 0 | 0 |
| Alkalinity | ASTM D3875 | 315 | 215 | 322 |
| (CaCO₃) (mg/L) | | | | |
| Total Hardness (mg/L) | APHA2340B | 4520 | 4.42 | 5970 |
| pH | ASTM D1293 | 7.68 | 7.91 | 7.72 |
| Conductivity (uS/cm) | ASTM D1125 | 184500 | 9690 | 174100 |
| Specific Gravity | ASTM D4052 | 1.1076 | 1.0044 | 1.0997 |

### Comparative Example 1

The aforementioned water softener was regenerated with a brine solution obtained by mixing natural salt and groundwater. The brine water in the mixing pit (“Sample 10”), the brine water in the holding pit (“Sample 11”) and the treated soft water (“Sample 12”) were analyzed for their contents and properties. Reject water from RO filter (“Sample 13”) was also analyzed for reference. A summary of water analyses is provided in Table 4.

TABLE 4

| Ion concentrations | | Sample | Sample | Sample | Sample |
|---|---|---|---|---|---|
| (mg/L) | | 10 | 11 | 12 | 13 |
| Sulfate (SO₄) | ASTM D516 | 2820 | 3260 | 598 | 1480 |
| Chloride (Cl) | ASTM D512 | 119000 | 117033 | 806 | 1676 |
| Barium (Ba) | ASTM D1976 | 0.05 | 0.06 | <0.01 | 0.11 |
| Strontium (Sr) | ASTM D1976 | 13 | 16 | 0.1 | 13 |
| Potassium (K) | ASTM D1976 | 318 | 302 | 3.78 | 89.7 |
| Calcium (Ca) | ASTM D1976 | 876 | 1120 | 2.74 | 568 |
| Magnesium (Mg) | ASTM D1976 | 667 | 610 | 1.05 | 226 |
| Sodium (Na) | ASTM D1976 | 84000 | 81000 | 900 | 1100 |
| CO₃ | ASTM D3875 | 0 | 0 | 0 | 0 |
| HCO₃ | ASTM D3875 | 214 | 208 | 265 | 672 |
| OH | ASTM D3875 | 0 | 0 | 0 | 0 |
| Alkalinity | ASTM D3875 | 175 | 171 | 217 | 551 |
| (CaCO₃) (mg/L) | | | | | |
| pH | ASTM D1293 | 7.32 | 7.53 | 7.95 | 7.79 |
| Conductivity (uS/cm) | ASTM D1125 | 222000 | 219000 | 3870 | 7870 |
| Specific Gravity | ASTM D4052 | 1.1439 | 1.1457 | 1.0019 | 1.0049 |

The test results show that the treated water obtained from the water softener in EXAMPLE 1 (as shown under “Sample 6” in Table 2), EXAMPLE 2 (as shown under “Sample 8” in Table 3) and COMPARATIVE EXAMPLE 1 (as shown under “Sample 12” in Table 4) contain similar amounts of calcium and magnesium ions, which are substantially low. Thus, the results indicate that the regeneration water produced by the RO filter is capable of regenerating the water softener in a similar manner as the brine solution, and such regeneration process may be repeated without affecting the performance of the water softener.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke means-plus-function for any limitations of any of the claims herein, except for those in which the claim expressly uses the words ‘means for’ together with an associated function.

What is claimed is:

1. A method for regenerating a water softener, comprising:
concentrating a source water comprising sodium ions and at least one of calcium ions and magnesium ions with a reverse osmosis (RO) filter to produce a regeneration water comprising sodium ions and at least one of calcium ions and magnesium ions; and
feeding the regeneration water through the water softener comprising a resin comprising at least one of calcium ions and magnesium ions to replace the at least one of calcium ions and magnesium ions with the sodium ions comprised in the regeneration water,
wherein the regeneration water has a ratio of sodium ions to a sum of magnesium ions and calcium ions in a range of from 10:1 to 10000:1.

2. The method of claim 1, further comprising adding sodium ions to the regeneration water prior to feeding the regeneration water through the water softener.

3. The method of claim 2, wherein the regeneration water has a sodium ion concentration of at least 50,000 mg/L.

4. The method of claim 1, wherein the regeneration water being fed through the water softener further comprises both calcium ions and magnesium ions.

5. The method of claim 4, wherein a concentration of calcium ions in the regeneration water is in a range of 0 to 3000 mg/L and a concentration of magnesium ions in the regeneration water is in a range of 0 to 2000 mg/L.

6. The method of claim 1, wherein the regeneration water has a specific gravity of at least 1.05.

7. The method of claim 1, wherein the regeneration water has a conductivity of at least 150,000 uS/cm.

8. The method of claim 1, wherein the feeding is conducted for a duration in a range of from 30 minutes to 120 minutes.

9. The method of claim 1, wherein a concentration of the sodium ions in the source water is in a range of from 50 to 20,000 mg/L.

10. The method of claim 1, wherein the source water is concentrated without being treated prior to the concentrating.

11. A method for producing and processing multiple water feed, comprising:
concentrating a source water comprising sodium ions and at least one of calcium ions and magnesium ions with a reverse osmosis (RO) filter to obtain a reject water comprising sodium ions and at least one of calcium ions and magnesium ions, and a purified water;
adding sodium ions to the reject water to produce a regeneration water;
feeding the regeneration water through a water softener comprising a resin comprising at least one of calcium ions and magnesium ions to replace the at least one of calcium ions and magnesium ions with the sodium ions comprised in the regeneration water; and
feeding the purified water through a process that requires a low solute concentration,
wherein:
the regeneration water has a ratio of sodium ions to a sum of magnesium ions and calcium ions in a range of from 10:1 to 10000:1, and
the source water comprises at least one of wastewater, groundwater and seawater.

12. The method of claim 11, wherein the regeneration water has a sodium ion concentration of at least 50,000 mg/L.

13. The method of claim 11, wherein the regeneration water being fed through the water softener further comprises both calcium ions and magnesium ions.

14. The method of claim 11, wherein a concentration of calcium ions in the regeneration water is in a range of 0 to 3000 mg/L.

15. The method of claim 11, wherein a concentration of magnesium ions in the regeneration water is in a range of 0 to 2000 mg/L.

16. The method of claim 11, wherein the regeneration water has a specific gravity of at least 1.05.

17. The method of claim 11, wherein the regeneration water has a conductivity of at least 150,000 uS/cm.

18. The method of claim 11, wherein the feeding the regeneration water through the water softener is conducted for a duration in a range of from 30 minutes to 120 minutes.

19. The method of claim 11, wherein a concentration of the sodium ions in the source water is in a range of from 50 to 20,000 mg/L.

20. A method, comprising:
desalinating groundwater in a desalination plant to produce a purified water stream and a groundwater concentrate stream comprising greater than 50 mg/L to less than 5,000 mg/L of calcium and magnesium ions;
adding sodium ions to the groundwater concentrate stream to produce a regeneration water having a ratio of sodium ions to a sum of magnesium ions and calcium ions in a range of from 10:1 to 10000:1,
feeding the purified water to a boiler or a steam generator to produce steam;
using the steam as a heat exchange medium in one or more heat exchangers of a refinery or a chemical plant; and
cyclically:
feeding a process water stream of the refinery or the chemical plant, the process water stream comprising hard water, to a water softener containing an ion exchange resin comprising sodium ions to produce a soft water process stream and a water softener containing spent ion exchange resin; and
feeding the regeneration water to the water softener containing spent ion exchange resin, regenerating the spent ion exchange resin by exchanging calcium and magnesium ions contained in the resin with sodium ions contained in the regeneration water to produce a regenerated resin and a hardened regeneration water.
